(19) United States
(12) Patent Application Publication
(10) Pub. No.: US 2020/0341587 A1
(43) Pub. Date: Oct. 29, 2020

(54) Thin Interactive Display

(71) Applicant: Rapt IP Limited, Mriehel (MT)

(72) Inventor: Owen Drumm, Dublin (IE)

(21) Appl. No.: 16/858,495

(22) Filed: Apr. 24, 2020

Related U.S. Application Data
(60) Provisional application No. 62/838,261, filed on Apr. 24, 2019.

(51) Int. Cl. G06F 3/042; G06F 3/03; G02B 6/12; G02B 6/30

(52) U.S. Cl. CPC G06F 3/0421; G06F 3/0308; G02B 2006/12035; G02B 6/30; G06F 2203/04101; G02B 6/12

(57) ABSTRACT

A thin touch sensitive display includes a display, an optical waveguide, emitters and detectors, and an enclosure. The display displays images. The optical waveguide extends over a surface of the display. The emitters and detectors are optically coupled to the optical waveguide. The emitters produce optical beams that propagate through the waveguide and are received by the detectors. Touch events on or near a surface of the optical waveguide disturb the optical beams. The enclosure is physically separate from the display and the optical waveguide. The enclosure houses electronic components that control the emitters and analyze signals from the detectors to determine a location of a touch event.

### CROSS REFERENCE TO RELATED APPLICATIONS

This application claims the benefit of priority to U.S. Provisional Patent Application No. 62/838,261, “Thin Interactive Display,” filed on Apr. 24, 2019, which is incorporated by reference in its entirety.

### BACKGROUND

### 1. Field of Art

This description generally relates to a touch sensitive interactive display, and specifically to an interactive display with an enclosure that is physically separate from a display and a touch sensitive waveguide and that houses electronic components configured to control emitters and to analyze signals from detectors to determine a location of a touch event.

### 2. Description of the Related Art

Touch-sensitive displays for interacting with computing devices are becoming more common. A number of different technologies exist for implementing touch-sensitive displays and other touch-sensitive devices. Examples of these techniques include, for example, resistive touch screens, surface acoustic wave touch screens, capacitive touch screens and certain types of optical touch screens.

However, many of these approaches currently suffer from drawbacks. For example, some technologies may function well for small sized displays, as used in many modern mobile phones, but do not scale well to larger screen sizes as in displays used with laptop or even desktop computers. For technologies that require a specially processed surface or the use of special elements in the surface, increasing the screen size by a linear factor of N means that the special processing must be scaled to handle the N2 larger area of the screen or that N2 times as many special elements are required. This can result in unacceptably low yields or prohibitively high costs.

Furthermore, for large screen sizes, the touch and display components typically result in an overall design which is heavy, bulky, and rigid. Due to this, installation is typically undertaken by individuals with appropriate training in lifting heavy objects and securing them safely in position. Furthermore, cantilever forces of the unit typically require specialized mounted components. Thus, there is a need for improved touch-sensitive display systems.

### SUMMARY

An optical touch-sensitive device may determine the locations of touch events. The optical touch-sensitive device includes multiple emitters and detectors. Each emitter produces optical radiant energy which is received by the detectors. In some embodiments, the optical emitters are frequency or code-division multiplexed in a manner so that many optical sources can be received by a detector simultaneously. Alternatively, emitters are time multiplexed and are activated sequentially in a predefined sequence. Touch events disturb the optical energy transfer from emitter to detector. Variations in light transfer resulting from the touch events are captured, and are used to determine the touch events. In one aspect, information indicating which emitter-detector pairs have been disturbed by touch events is received. The light disturbance for each pair is characterized and used to determine the beams attenuation resulting from the touch events.

The emitters and detectors may be interleaved around the periphery of the touch sensitive surface. In other embodiments, the number of emitters and detectors are different and are distributed around the periphery in a defined order. The emitters and detectors may be regularly or irregularly spaced. In some cases, the emitters and/or detectors are located on less than all of the sides (e.g., one side). In some cases, the emitters and/or detectors are not physically located at the periphery. For example, couplers, such as waveguides, couple beams between the touch surface and the emitters and/or detectors. Reflectors may also be positioned around the periphery to reflect optical beams, causing the path from the emitter to the detector to pass across the surface more than once. For each emitter-detector pair, a beam may be defined by combining light rays propagating from an emitter and a detector. In some implementations, the disturbance of a beam is characterized by its transmission coefficient, and the beam attenuation is determined from the transmission coefficient.

Some embodiments relate to a touch-sensitive interactive display. The interactive display includes a display, an optical waveguide, emitters and detectors, and an enclosure. The display displays images. The optical waveguide extends over a surface of the display. The emitters and detectors are optically coupled to the optical waveguide. The emitters produce optical beams that propagate through the waveguide and are received by the detectors. Touch events on or near a surface of the optical waveguide disturb the optical beams. The enclosure is physically separate from the display and the optical waveguide. The enclosure houses electronic components that control the emitters and analyze signals from the detectors to determine a location of a touch event.

A controller and a touch event processor may be housed in the enclosure. In some embodiments, the emitters and detectors are arranged along a portion of a periphery of the optical waveguide. The interactive display may include emitter drive circuits that are arranged along a portion of the periphery of the optical waveguide. The drive circuits can regulate emitter currents in cables that connect the controller to the emitters. In some embodiments, a single emitter drive circuit is housed in the enclosure and can regulate emitter currents in the cables. A drive circuit may regulate emitter currents based on reactances of the cables.

In some embodiments, the interactive display includes one or more detector drive circuits. To support the transmission of detector outputs over relatively long cables to a controller located in the enclosure, techniques may be used to maintain the signal integrity of data values transmitted from the detector circuitry to the controller.

A power supply of the display, emitters, and detectors may be housed in the enclosure. In some embodiments, the waveguide includes a laminated structure with one or more layers applied to the surface of the display. The optical waveguide may be made of a polymer and may conform to the surface of the display.

In some embodiments, the enclosure includes a proximity sensor that detects when a user is near the enclosure. In these embodiments, the electronic components housed in the enclosure may transition from a low power mode to a touch detection mode responsive to the proximity sensor detecting a user is near the enclosure.

A combined thickness of the display and optical waveguide may be between 1.5 millimeters and 30 millimetres. A thickness of the optical waveguide may be between 0.02 millimeters and 1.6 millimeters. A total weight of the interactive display may be between 10 kilograms and 30 kilograms.

The interactive display may include a reflective material on one or more regions of the waveguide, where the reflective material renders the one or more regions touch insensitive. The interactive display may include a barrier layer above the surface of the optical waveguide that may render one or more regions less touch sensitive or touch insensitive. The barrier layer has an index of refraction less than an index of refraction of the optical waveguide and one or more regions of the barrier layer may have a thickness less than an evanescent field depth of the optical beams. The thickness of the barrier layer may vary such that the one or more regions of the barrier layer have a thickness less than the evanescent field depth and one or more other regions have a thickness larger than the evanescent field depth. In some cases the thickness of the one or more regions of the barrier layer is based on the thickness of the optical waveguide. The thickness of the one or more regions of the barrier layer may be selected such that an optical transmission between each emitter and detector is at least 20% in the absence of touch events. The one or more regions of the barrier layer may have thicknesses between 30%-95% of the evanescent field depth of the optical beams.

### BRIEF DESCRIPTION OF DRAWINGS

Embodiments of the present disclosure will now be described, by way of example, with reference to the accompanying drawings.

FIG. 1 is a diagram of an optical touch-sensitive device, according to an embodiment.

FIG. 2 is a flow diagram for determining the characteristics of touch events, according to an embodiment.

FIG. 3A-3F illustrate example mechanisms for a touch interaction with an optical beam, according to some embodiments.

FIG. 4 is a graph of binary and analog touch interactions, according to an embodiment.

FIGS. 5A-5C are top views of differently shaped beam footprints, according to some embodiments.

FIGS. 6A-6B are top views illustrating a touch point travelling through a narrow beam and a wide beam, respectively, according to some embodiments.

FIG. 7 is a graph of the binary and analog responses for the narrow and wide beams of FIG. 6, according to some embodiments.

FIGS. 8A and 8B are top views illustrating active touch area coverage by emitters, according to some embodiments.

FIGS. 8C and 8D are top views illustrating active touch area coverage by detectors, according to some embodiments.

FIG. 8E is a top view illustrating alternating emitters and detectors, according to an embodiment.

FIGS. 9A-9C are top views illustrating beam patterns interrupted by a touch point, from the viewpoint of different beam terminals, according to some embodiments.

FIG. 9D is a top view illustrating estimation of the touch point, based on the interrupted beams of FIGS. 9A-9C and the line images of FIGS. 10A-10C, according to an embodiment.

FIGS. 10A-10C are graphs of line images corresponding to the cases shown in FIGS. 9A-9C, according to some embodiments.

FIG. 11A is a top view illustrating a touch point travelling through two adjacent wide beams, according to an embodiment.

FIG. 11B are graphs of the analog responses for the two wide beams of FIG. 11A, according to some embodiments.

FIG. 11C is a top view illustrating a touch point travelling through many adjacent narrow beams, according to an embodiment.

FIGS. 12A-12E are top views of beam paths illustrating templates for touch events, according to some embodiments.

FIG. 13 is a flow diagram of a multi-pass method for determining touch locations, according to some embodiments.

FIGS. 14A-14C illustrate thin interactive display, according to some embodiments.

FIG. 15 illustrates light propagating in a thick waveguide and light propagating in a thin waveguide, according to an embodiment.

FIG. 16 illustrates a sensing barrier layer on a waveguide, according to an embodiment.

### DETAILED DESCRIPTION

### I. Introduction

A. Device Overview

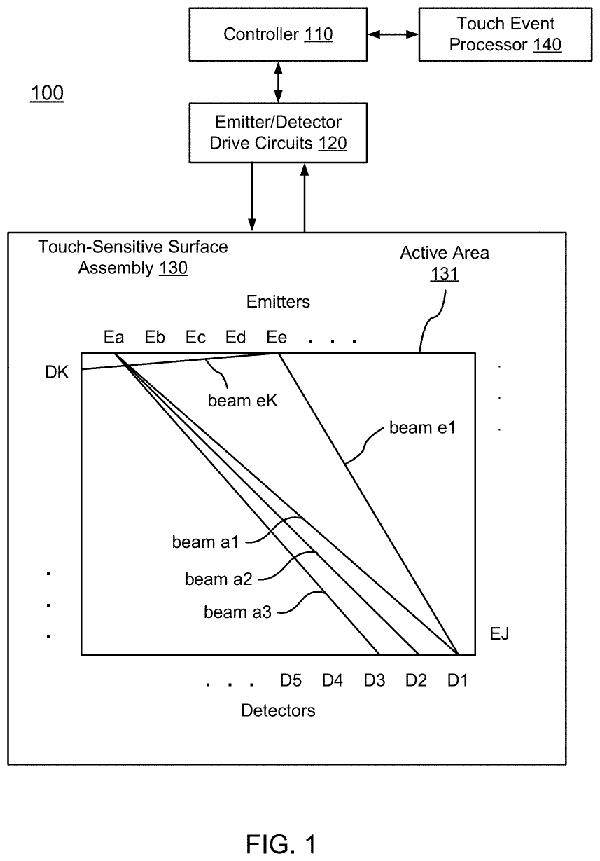

FIG. 1 is a diagram of an optical touch-sensitive device 100 (also referred to as a touch system, touch-sensitive device, or touch sensor), according to one embodiment. The optical touch-sensitive device 100 includes a controller 110, emitter/detector drive circuits 120, and a touch-sensitive surface assembly 130. The surface assembly 130 includes a surface 131 over which touch events are to be detected. For convenience, the area defined by surface 131 may sometimes be referred to as the active touch area, touch surface, or active touch surface, even though the surface itself may be an entirely passive structure. The assembly 130 also includes emitters and detectors arranged along the periphery of the active touch surface 131. In this example, there are J emitters labeled as Ea-EJ and K detectors labeled as D1-DK. The device also includes a touch event processor 140, which may be implemented as part of the controller 110 or separately as shown in FIG. 1. A standardized API may be used to communicate with the touch event processor 140, for example between the touch event processor 140 and controller 110, or between the touch event processor 140 and other devices connected to the touch event processor.

The emitter/detector drive circuits 120 serve as an interface between the controller 110 and the emitters Ej and detectors Dk. The emitters produce optical “beams” which are received by the detectors. Preferably, the light produced by one emitter is received by more than one detector, and each detector receives light from more than one emitter. For convenience, “beam” will refer to the light from one emitter to one detector, even though it may be part of a large fan of light that goes to many detectors rather than a separate beam. The beam from emitter Ej to detector Dk will be referred to as beam jk. FIG. 1 expressly labels beams a1, a2, a3, e1 and eK as examples. Touches within the active touch area 131 will disturb certain beams, thus changing what is received at the detectors Dk. Data about these changes is communicated to the touch event processor 140, which analyzes the data to determine the location(s) (and times) of touch events on surface 131.

The emitters and detectors may be interleaved around the periphery of the sensitive surface. In other embodiments, the number of emitters and detectors are different and are distributed around the periphery in any defined order. The emitters and detectors may be regularly or irregularly spaced. In some cases, the emitters and/or detectors may be located on less than all of the sides (e.g., one side). In some embodiments, the emitters and/or detectors are not located around the periphery (e.g., beams are directed to/from the active touch area 131 by optical beam couplers). Reflectors may also be positioned around the periphery to reflect optical beams, causing the path from the emitter to the detector to pass across the surface more than once.

One advantage of an optical approach as shown in FIG. 1 is that this approach scales well to larger screen sizes compared to conventional touch devices that cover an active touch area with sensors, such as resistive and capacitive sensors. Since the emitters and detectors may be positioned around the periphery, increasing the screen size by a linear factor of N means that the periphery also scales by a factor of N compared to N² for conventional touch devices.

B. Process Overview

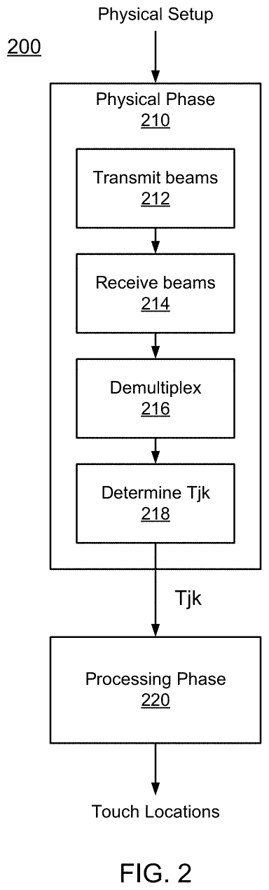

FIG. 2 is a flow diagram for determining the characteristics of touch events, according to an embodiment. This process will be illustrated using the device of FIG. 1. The process 200 is roughly divided into two phases, which will be referred to as a physical phase 210 and a processing phase 220. Conceptually, the dividing line between the two phases is a set of transmission coefficients Tjk (also referred to as transmission values Tjk).

The transmission coefficient Tjk is the transmittance of the optical beam from emitter j to detector k, compared to what would have been transmitted if there was no touch event interacting with the optical beam. In the following examples, we will use a scale of 0 (fully blocked beam) to 1 (fully transmitted beam). Thus, a beam jk that is undisturbed by a touch event has Tjk=1. A beam jk that is fully blocked by a touch event has a Tjk=0. A beam jk that is partially blocked or attenuated by a touch event has 0<Tjk<1. It is possible for Tjk>1, for example depending on the nature of the touch interaction or in cases where light is deflected or scattered to detectors k that it normally would not reach.

The use of this specific measure is purely an example. Other measures can be used. In particular, since we are most interested in interrupted beams, an inverse measure such as (1−Tjk) may be used since it is normally 0. Other examples include measures of absorption, attenuation, reflection, or scattering. In addition, although FIG. 2 is explained using Tjk as the dividing line between the physical phase 210 and the processing phase 220, it is not required that Tjk be expressly calculated. Nor is a clear division between the physical phase 210 and processing phase 220 required.

Returning to FIG. 2, the physical phase 210 is the process of determining the Tjk from the physical setup. The processing phase 220 determines the touch events from the Tjk. The model shown in FIG. 2 is conceptually useful because it somewhat separates the physical setup and underlying physical mechanisms from the subsequent processing.

For example, the physical phase 210 produces transmission coefficients Tjk. Many different physical designs for the touch-sensitive surface assembly 130 are possible, and different design tradeoffs will be considered depending on the end application. For example, the emitters and detectors may be narrower or wider, narrower angle or wider angle, various wavelengths, various powers, coherent or not, etc. As another example, different types of multiplexing may be used to allow beams from multiple emitters to be received by each detector. Several of these physical setups and manners of operation are described below, primarily in Section II.

The interior of block 210 shows one possible implementation of process 210. In this example, emitters transmit 212 beams to multiple detectors. Some of the beams travelling across the touch-sensitive surface are disturbed by touch events. The detectors receive 214 the beams from the emitters in a multiplexed optical form. The received beams are de-multiplexed 216 to distinguish individual beams jk from each other. Transmission coefficients Tjk for each individual beam jk are then determined 218.

The processing phase 220 computes the touch characteristics and can be implemented in many different ways. Candidate touch points, line imaging, location interpolation, touch event templates and multi-pass approaches are all examples of techniques that may be used to compute the touch characteristics (such as touch location and touch strength) as part of the processing phase 220. Several of these are identified in Section III.

### II. Physical Set-Up

The touch-sensitive device 100 may be implemented in a number of different ways. The following are some examples of design variations.

A. Electronics

With respect to electronic aspects, note that FIG. 1 is exemplary and functional in nature. Functions from different boxes in FIG. 1 can be implemented together in the same component.

For example, the controller 110 and touch event processor 140 may be implemented as hardware, software or a combination of the two. They may also be implemented together (e.g., as an SoC with code running on a processor in the SoC) or separately (e.g., the controller as part of an ASIC, and the touch event processor as software running on a separate processor chip that communicates with the ASIC). Example implementations include dedicated hardware (e.g., ASIC or programmed field programmable gate array (FPGA)), and microprocessor or microcontroller (either embedded or standalone) running software code (including firmware). Software implementations can be modified after manufacturing by updating the software.

The emitter/detector drive circuits 120 serve as an interface between the controller 110 and the emitters and detectors. In one implementation, the interface to the controller 110 is at least partly digital in nature. With respect to emitters, the controller 110 may send commands controlling the operation of the emitters. These commands may be instructions, for example a sequence of bits which mean to take certain actions: start/stop transmission of beams, change to a certain pattern or sequence of beams, adjust power, power up/power down circuits. They may also be simpler signals, for example a “beam enable signal,” where the emitters transmit beams when the beam enable signal is high and do not transmit when the beam enable signal is low.

The circuits 120 convert the received instructions into physical signals that drive the emitters. For example, circuit 120 might include some digital logic coupled to digital to analog converters, in order to convert received digital instructions into drive currents for the emitters. The circuit 120 might also include other circuitry used to operate the emitters: modulators to impress electrical modulations onto the optical beams (or onto the electrical signals driving the emitters), control loops and analog feedback from the emitters, for example. The emitters may also send information to the controller, for example providing signals that report on their current status.

With respect to the detectors, the controller 110 may also send commands controlling the operation of the detectors, and the detectors may return signals to the controller. The detectors also transmit information about the beams received by the detectors. For example, the circuits 120 may receive raw or amplified analog signals from the detectors. The circuits then may condition these signals (e.g., noise suppression), convert them from analog to digital form, and perhaps also apply some digital processing (e.g., demodulation).

B. Touch Interactions

Not all touch objects are equally good beam attenuators, as indicated by their transmission coefficient Tjk. Beam attenuation mainly depends on the optical transparency of the object and the volume of the object portion that is interacting with the beam, i.e. the object portion that intersects the beam propagation volume.

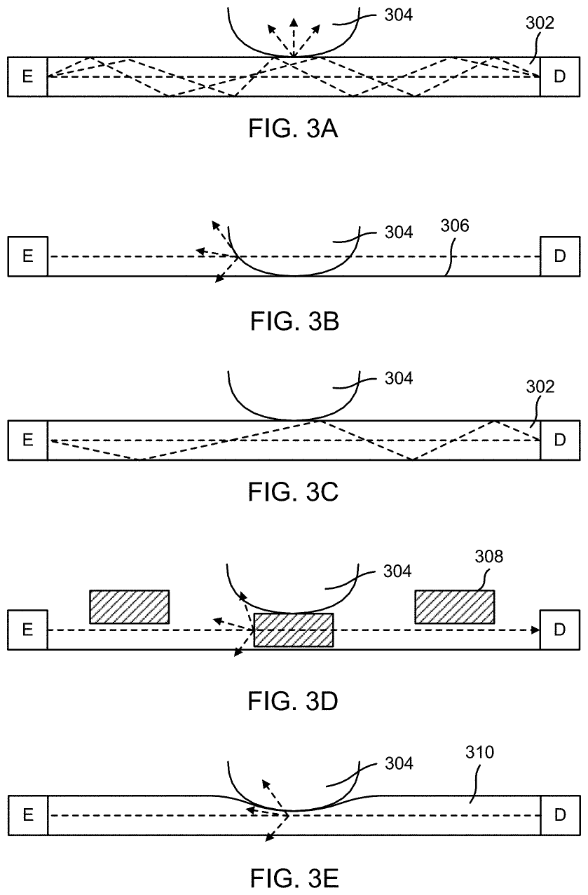

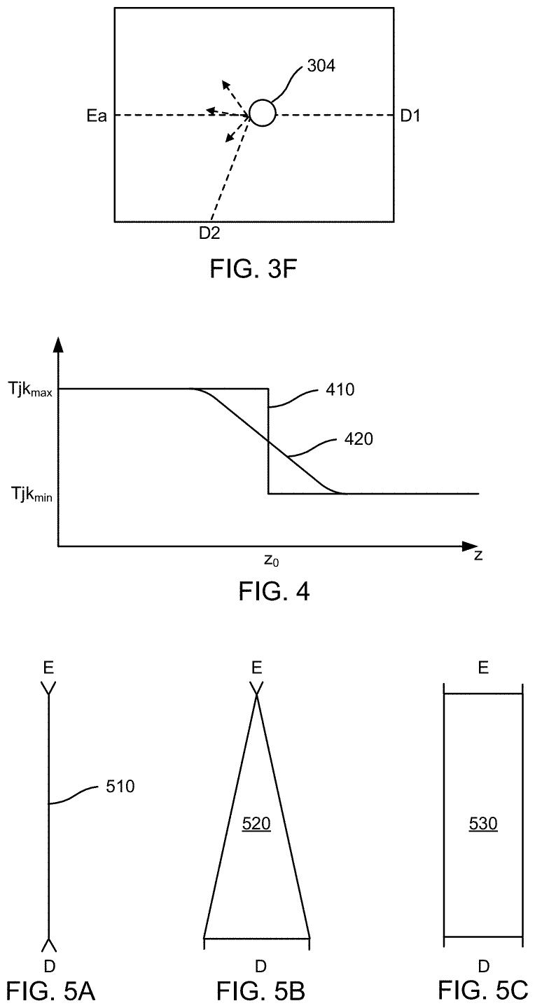

FIGS. 3A-3F illustrate different mechanisms for a touch interaction with an optical beam. FIG. 3A illustrates a mechanism based on frustrated total internal reflection (referred to as TIR or FTIR). The optical beam, shown as a dashed line, travels from emitter E to detector D through an optically transparent planar waveguide 302. The beam is confined to the waveguide 302 by total internal reflection. The waveguide may be constructed of plastic or glass, for example. An object 304, such as a finger or stylus, coming into contact with the transparent waveguide 302, has a higher refractive index than the air normally surrounding the waveguide. Over the area of contact, the increase in the refractive index due to the object disturbs the total internal reflection of the beam within the waveguide. The disruption of total internal reflection increases the light leakage from the waveguide, attenuating any beams passing through the contact area. Correspondingly, removal of the object 304 will stop the attenuation of the beams passing through. Attenuation of the beams passing through the touch point will result in less power at the detectors, from which the reduced transmission coefficients Tjk can be calculated.

FIG. 3B illustrates a mechanism based on beam blockage (also referred to as an “over the surface” (OTS) configuration). Emitters produce beams which are in close proximity to a surface 306. An object 304 coming into contact with the surface 306 will partially or entirely block beams within the contact area. FIGS. 3A and 3B illustrate two physical mechanisms for touch interactions, but other mechanisms can also be used. For example, the touch interaction may be based on changes in polarization, scattering, or changes in propagation direction or propagation angle (either vertically or horizontally).

For example, FIG. 3C illustrates a different mechanism based on propagation angle. In this example, the optical beam is guided in a waveguide 302 via TIR. The optical beam hits the waveguide-air interface at a certain angle and is reflected back at the same angle. However, the touch 304 changes the angle at which the optical beam is propagating, and may also absorb some of the incident light. In FIG. 3C, the optical beam travels at a steeper angle of propagation after the touch 304. Note that changing the angle of the light may also cause it to fall below the critical angle for total internal reflection, whereby it will leave the waveguide. The detector D has a response that varies as a function of the angle of propagation. The detector D could be more sensitive to the optical beam travelling at the original angle of propagation or it could be less sensitive. Regardless, an optical beam that is disturbed by a touch 304 will produce a different response at detector D.

In FIGS. 3A-3C, the touching object was also the object that interacted with the beam. This will be referred to as a direct interaction. In an indirect interaction, the touching object interacts with an intermediate object, which interacts with the optical beam. FIG. 3D shows an example that uses intermediate blocking structures 308. Normally, these structures 308 do not block the beam. However, in FIG. 3D, object 304 contacts the blocking structure 308, which causes it to partially or entirely block the optical beam. In FIG. 3D, the structures 308 are shown as discrete objects, but they do not have to be so.

In FIG. 3E, the intermediate structure 310 is a compressible, partially transmitting sheet. When there is no touch, the sheet attenuates the beam by a certain amount. In FIG. 3E, the touch 304 compresses the sheet, thus changing the attenuation of the beam. For example, the upper part of the sheet may be more opaque than the lower part, so that compression decreases the transmittance. Alternatively, the sheet may have a certain density of scattering sites. Compression increases the density in the contact area, since the same number of scattering sites occupies a smaller volume, thus decreasing the transmittance. Analogous indirect approaches can also be used for frustrated TIR. Note that this approach could be used to measure contact pressure or touch velocity, based on the degree or rate of compression.

The touch mechanism may also enhance transmission, instead of or in addition to reducing transmission. For example, the touch interaction in FIG. 3E might increase the transmission instead of reducing it. The upper part of the sheet may be more transparent than the lower part, so that compression increases the transmittance.

FIG. 3F shows another example where the transmittance between an emitter and detector increases due to a touch interaction. FIG. 3F is a top view. Emitter Ea normally produces a beam that is received by detector D1. When there is no touch interaction, Ta1=1 and Ta2=0. However, a touch interaction 304 blocks the beam from reaching detector D1 and scatters some of the blocked light to detector D2. Thus, detector D2 receives more light from emitter Ea than it normally would. Accordingly, when there is a touch event 304, Ta1 decreases and Ta2 increases.

For simplicity, in the remainder of this description, the touch mechanism will be assumed to be primarily of a blocking nature, meaning that a beam from an emitter to a detector will be partially or fully blocked by an intervening touch event. This is not required, but it is convenient to illustrate various concepts.

For convenience, the touch interaction mechanism may sometimes be classified as either binary or analog. A binary interaction is one that basically has two possible responses as a function of the touch. Examples includes non-blocking and fully blocking, or non-blocking and 10%+ attenuation, or not frustrated and frustrated TIR. An analog interaction is one that has a “grayscale” response to the touch: non-blocking passing through gradations of partially blocking to blocking. Whether the touch interaction mechanism is binary or analog depends in part on the nature of the interaction between the touch and the beam. It does not depend on the lateral width of the beam (which can also be manipulated to obtain a binary or analog attenuation, as described below), although it might depend on the vertical size of the beam.

FIG. 4 is a graph illustrating a binary touch interaction mechanism compared to an analog touch interaction mechanism. FIG. 4 graphs the transmittance Tjk as a function of the depth z of the touch. The dimension z is into and out of the active touch surface. Curve 410 is a binary response. At low z (i.e., when the touch has not yet disturbed the beam), the transmittance Tjk is at its maximum. However, at some point z0, the touch breaks the beam and the transmittance Tjk falls fairly suddenly to its minimum value. Curve 420 shows an analog response where the transition from maximum Tjk to minimum Tjk occurs over a wider range of z. If curve 420 is well behaved, it is possible to estimate z from the measured value of Tjk.

C. Emitters, Detectors and Couplers

Each emitter transmits light to a number of detectors. Usually, each emitter outputs light to more than one detector simultaneously. Similarly, each detector may receive light from a number of different emitters. The optical beams may be visible, infrared (IR) and/or ultraviolet light. The term “light” is meant to include all of these wavelengths and terms such as “optical” are to be interpreted accordingly.

Examples of the optical sources for the emitters include light emitting diodes (LEDs) and semiconductor lasers. IR sources can also be used. Modulation of optical beams can be achieved by directly modulating the optical source or by using an external modulator, for example a liquid crystal modulator or a deflected mirror modulator. Examples of sensor elements for the detector include charge coupled devices, photodiodes, photoresistors, phototransistors, and nonlinear all-optical detectors. Typically, the detectors output an electrical signal that is a function of the intensity of the received optical beam.

The emitters and detectors may also include optics and/or electronics in addition to the main optical source and sensor element. For example, optics can be used to couple between the emitter/detector and the desired beam path. Optics can also reshape or otherwise condition the beam produced by the emitter or accepted by the detector. These optics may include lenses, Fresnel lenses, mirrors, filters, non-imaging optics and other optical components.

In this disclosure, the optical paths are shown unfolded for clarity. Thus, sources, optical beams and sensors are shown as lying in one plane. In actual implementations, the sources and sensors typically do not lie in the same plane as the optical beams. Various coupling approaches can be used. For example, a planar waveguide or optical fiber may be used to couple light to/from the actual beam path. Free space coupling (e.g., lenses and mirrors) may also be used. A combination may also be used, for example waveguided along one dimension and free space along the other dimension. Various coupler designs are described in U.S. Pat. No. 9,170,683, entitled “Optical Coupler,” which is incorporated by reference herein.

D. Optical Beam Paths

Another aspect of a touch-sensitive system is the shape and location of the optical beams and beam paths. In FIG. 1, the optical beams are shown as lines. These lines should be interpreted as representative of the beams, but the beams themselves are not necessarily narrow pencil beams. FIGS. 5A-5C illustrate different beam shapes when projected onto the active touch surface (beam footprint).

FIG. 5A shows a point emitter E, point detector D and a narrow “pencil” beam 510 from the emitter to the detector. In FIG. 5B, a point emitter E produces a fan-shaped beam 520 received by the wide detector D. In FIG. 5C, a wide emitter E produces a “rectangular” beam 530 received by the wide detector D. These are top views of the beams and the shapes shown are the footprints of the beam paths. Thus, beam 510 has a line-like footprint, beam 520 has a triangular footprint which is narrow at the emitter and wide at the detector, and beam 530 has a fairly constant width rectangular footprint. In FIG. 5, the detectors and emitters are represented by their widths, as seen by the beam path. The actual optical sources and sensors may not be so wide. Rather, optics (e.g., cylindrical lenses or mirrors) can be used to effectively widen or narrow the lateral extent of the actual sources and sensors.

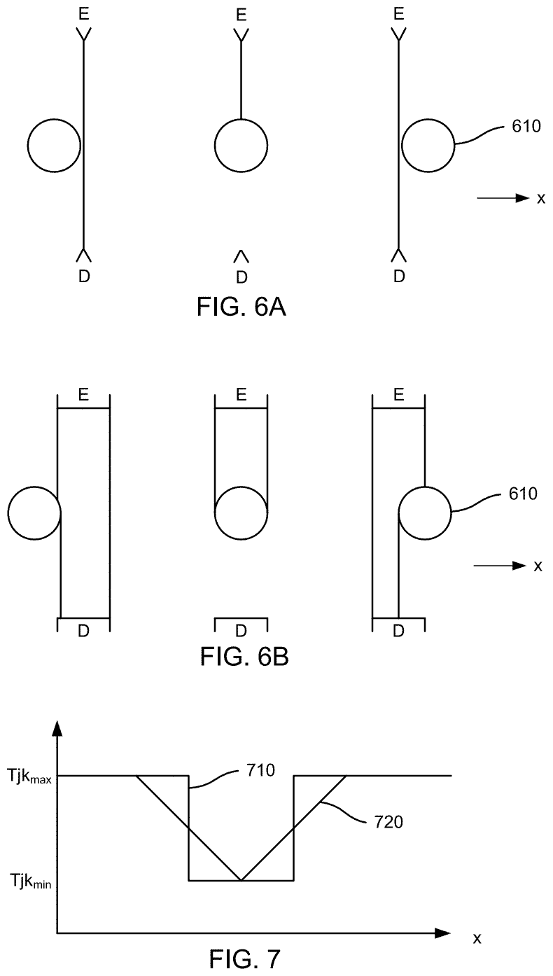

FIGS. 6A-6B and 7 show, for a constant z position and various x positions, how the width of the footprint can determine whether the transmission coefficient Tjk behaves as a binary or analog quantity. In these figures, a touch point has contact area 610. Assume that the touch is fully blocking, so that any light that hits contact area 610 will be blocked. FIG. 6A shows what happens as the touch point moves left to right past a narrow beam. In the leftmost situation, the beam is not blocked at all (i.e., maximum Tjk) until the right edge of the contact area 610 interrupts the beam. At this point, the beam is fully blocked (i.e., minimum Tjk), as is also the case in the middle scenario. It continues as fully blocked until the entire contact area moves through the beam. Then, the beam is again fully unblocked, as shown in the righthand scenario. Curve 710 in FIG. 7 shows the transmittance Tjk as a function of the lateral position x of the contact area 610. The sharp transitions between minimum and maximum Tjk show the binary nature of this response.

FIG. 6B shows what happens as the touch point moves left to right past a wide beam. In the leftmost scenario, the beam is just starting to be blocked. The transmittance Tjk starts to fall off but is at some value between the minimum and maximum values. The transmittance Tjk continues to fall as the touch point blocks more of the beam, until the middle situation where the beam is fully blocked. Then the transmittance Tjk starts to increase again as the contact area exits the beam, as shown in the righthand situation. Curve 720 in FIG. 7 shows the transmittance Tjk as a function of the lateral position x of the contact area 610. The transition over a broad range of x shows the analog nature of this response.

E. Active Area Coverage

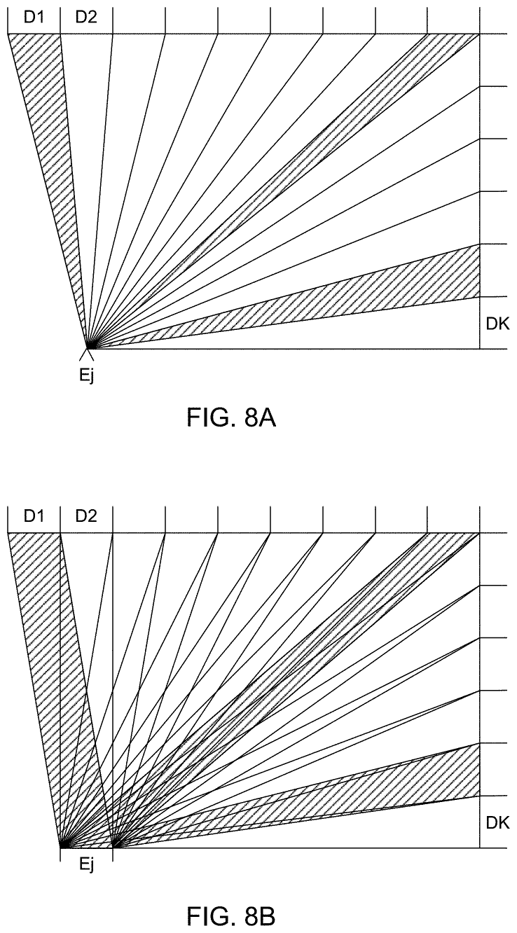

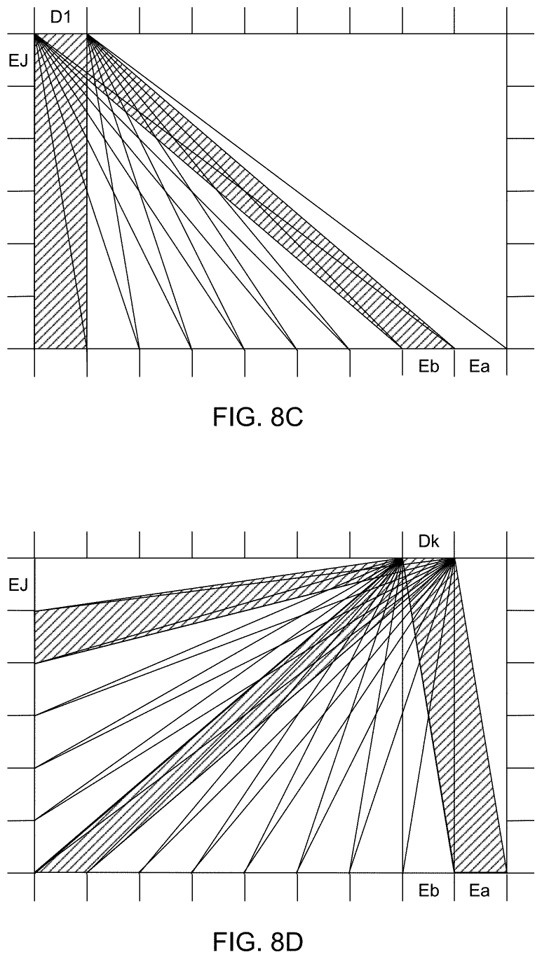

FIG. 8A is a top view illustrating the beam pattern produced by a point emitter.

Emitter Ej transmits beams to wide detectors D1-DK. Three beams are shaded for clarity: beam j1, beam j(K−1) and an intermediate beam. Each beam has a fan-shaped footprint. The aggregate of all footprints is emitter Ej's coverage area. That is, any touch event that falls within emitter Ej's coverage area will disturb at least one of the beams from emitter Ej. FIG. 8B is a similar diagram, except that emitter Ej is a wide emitter and produces beams with “rectangular” footprints (actually, trapezoidal but they are referred to as rectangular for convenience). The three shaded beams are for the same detectors as in FIG. 8A.

Note that every emitter Ej may not produce beams for every detector Dk. In FIG. 1, consider beam path aK which would go from emitter Ea to detector DK. First, the light produced by emitter Ea may not travel in this direction (i.e., the radiant angle of the emitter may not be wide enough) so there may be no physical beam at all, or the acceptance angle of the detector may not be wide enough so that the detector does not detect the incident light. Second, even if there was a beam and it was detectable, it may be ignored because the beam path is not located in a position to produce useful information. Hence, the transmission coefficients Tjk may not have values for all combinations of emitters Ej and detectors Dk.

The footprints of individual beams from an emitter and the coverage area of all beams from an emitter can be described using different quantities. Spatial extent (i.e., width), angular extent (i.e., radiant angle for emitters, acceptance angle for detectors), and footprint shape are quantities that can be used to describe individual beam paths as well as an individual emitter's coverage area.

An individual beam path from one emitter Ej to one detector Dk can be described by the emitter Ej's width, the detector Dk's width and/or the angles and shape defining the beam path between the two.

These individual beam paths can be aggregated over all detectors for one emitter Ej to produce the coverage area for emitter Ej. Emitter Ej's coverage area can be described by the emitter Ej's width, the aggregate width of the relevant detectors Dk and/or the angles and shape defining the aggregate of the beam paths from emitter Ej. Note that the individual footprints may overlap (see FIG. 8B close to the emitter). Therefore, an emitter's coverage area may not be equal to the sum of its footprints. The ratio of (the sum of an emitter's footprints)/(emitter's cover area) is one measure of the amount of overlap.

The coverage areas for individual emitters can be aggregated over all emitters to obtain the overall coverage for the system. In this case, the shape of the overall coverage area is not so interesting because it should cover the entirety of the active touch area 131. However, not all points within the active touch area 131 will be covered equally. Some points may be traversed by many beam paths while other points traversed by far fewer. The distribution of beam paths over the active touch area 131 may be characterized by calculating how many beam paths traverse different (x,y) points within the active touch area. The orientation of beam paths is another aspect of the distribution. An (x,y) point that is derived from three beam paths that are all running roughly in the same direction usually will be a weaker distribution than a point that is traversed by three beam paths that all run at 60 degree angles to each other.

The discussion above for emitters also holds for detectors. The diagrams constructed for emitters in FIGS. 8A-8B can also be constructed for detectors. For example, FIG. 8C shows a similar diagram for detector D1 of FIG. 8B. That is, FIG. 8C shows all beam paths received by detector D1. Note that in this example, the beam paths to detector D1 are only from emitters along the bottom edge of the active touch area. The emitters on the left edge are not worth connecting to D1 and there are no emitters on the right edge (in this example design). FIG. 8D shows a diagram for detector Dk, which is an analogous position to emitter Ej in FIG. 8B.

A detector Dk's coverage area is then the aggregate of all footprints for beams received by a detector Dk. The aggregate of all detector coverage areas gives the overall system coverage.

The coverage of the active touch area 131 depends on the shapes of the beam paths, but also depends on the arrangement of emitters and detectors. In most applications, the active touch area is rectangular in shape, and the emitters and detectors are located along the four edges of the rectangle.

In a preferred approach, rather than having only emitters along certain edges and only detectors along the other edges, emitters and detectors are interleaved along the edges. FIG. 8E shows an example of this where emitters and detectors are alternated along all four edges. The shaded beams show the coverage area for emitter Ej.

F. Multiplexing

Since multiple emitters transmit multiple optical beams to multiple detectors, and since the behavior of individual beams is generally desired, a multiplexing/demultiplexing scheme is used. For example, each detector typically outputs a single electrical signal indicative of the intensity of the incident light, regardless of whether that light is from one optical beam produced by one emitter or from many optical beams produced by many emitters. However, the transmittance Tjk is a characteristic of an individual optical beam jk.

Different types of multiplexing can be used. Depending upon the multiplexing scheme used, the transmission characteristics of beams, including their content and when they are transmitted, may vary. Consequently, the choice of multiplexing scheme may affect both the physical construction of the optical touch-sensitive device as well as its operation.

One approach is based on code division multiplexing. In this approach, the optical beams produced by each emitter are encoded using different codes. A detector receives an optical signal which is the combination of optical beams from different emitters, but the received beam can be separated into its components based on the codes. This is described in further detail in U.S. Pat. No. 8,227,742, entitled “Optical Control System With Modulated Emitters,” which is incorporated by reference herein.

Another similar approach is frequency division multiplexing. In this approach, rather than modulated by different codes, the optical beams from different emitters are modulated by different frequencies. The frequencies are low enough that the different components in the detected optical beam can be recovered by electronic filtering or other electronic or software means.

Time division multiplexing can also be used. In this approach, different emitters transmit beams at different times. The optical beams and transmission coefficients Tjk are identified based on timing. If only time multiplexing is used, the controller cycles through the emitters quickly enough to meet a specified touch sampling rate.

Other multiplexing techniques commonly used with optical systems include wavelength division multiplexing, polarization multiplexing, spatial multiplexing and angle multiplexing. Electronic modulation schemes, such as PSK, QAM and OFDM, may also be possibly applied to distinguish different beams.

Several multiplexing techniques may be used together. For example, time division multiplexing and code division multiplexing could be combined. Rather than code division multiplexing 128 emitters or time division multiplexing 128 emitters, the emitters might be broken down into 8 groups of 16. The 8 groups are time division multiplexed so that only 16 emitters are operating at any one time, and those 16 emitters are code division multiplexed. This might be advantageous, for example, to minimize the number of emitters active at any given point in time to reduce the power requirements of the device.

### III. Processing Phase

In the processing phase 220 of FIG. 2, the transmission coefficients Tjk are used to determine the locations of touch points. Different approaches and techniques can be used, including candidate touch points, line imaging, location interpolation, touch event templates, multi-pass processing and beam weighting.

A. Candidate Touch Points

One approach to determine the location of touch points is based on identifying beams that have been affected by a touch event (based on the transmission coefficients Tjk) and then identifying intersections of these interrupted beams as candidate touch points. The list of candidate touch points can be refined by considering other beams that are in proximity to the candidate touch points or by considering other candidate touch points. This approach is described in further detail in U.S. Pat. No. 8,350,831, “Method and Apparatus for Detecting a Multitouch Event in an Optical Touch-Sensitive Device,” which is incorporated herein by reference.

B. Line Imaging

This technique is based on the concept that the set of beams received by a detector form a line image of the touch points, where the viewpoint is the detector's location. The detector functions as a one-dimensional camera that is looking at the collection of emitters. Due to reciprocity, the same is also true for emitters. The set of beams transmitted by an emitter form a line image of the touch points, where the viewpoint is the emitter's location.

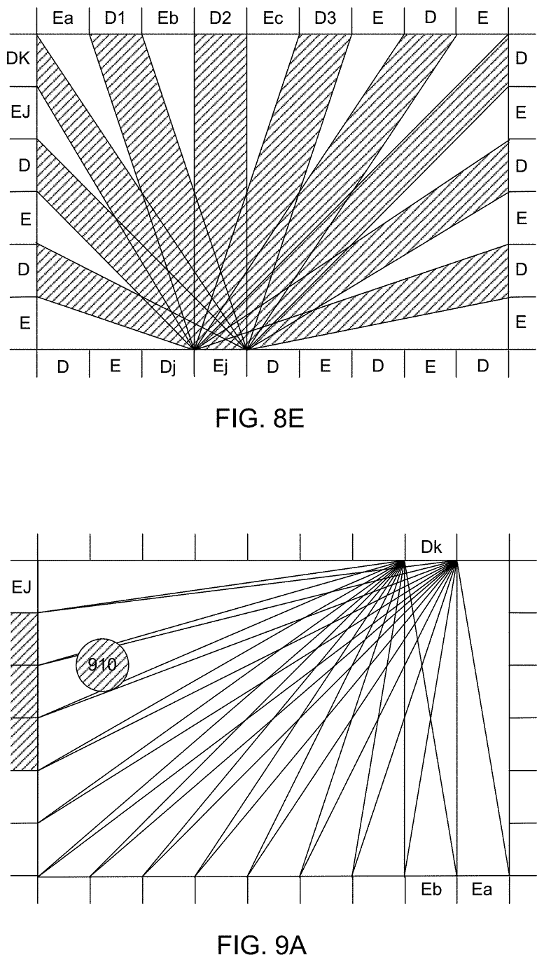

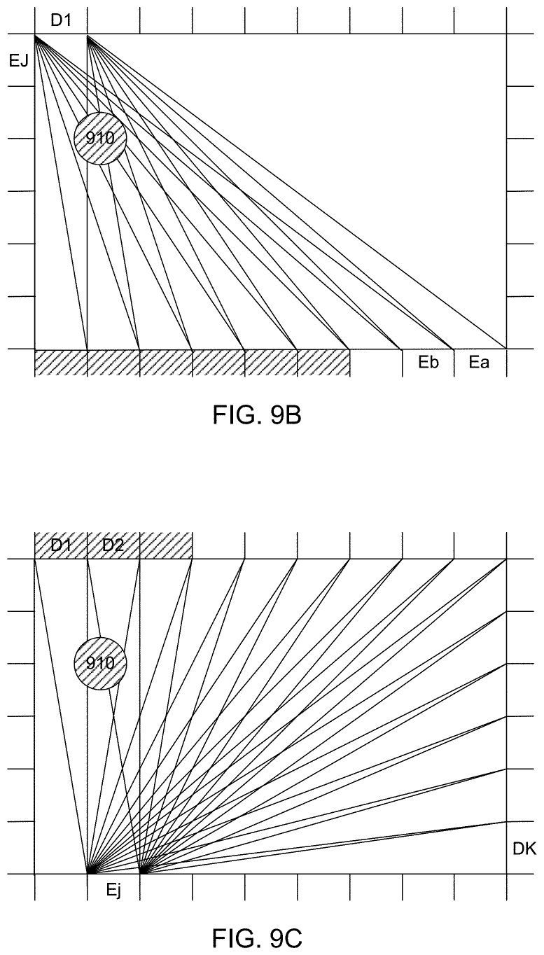

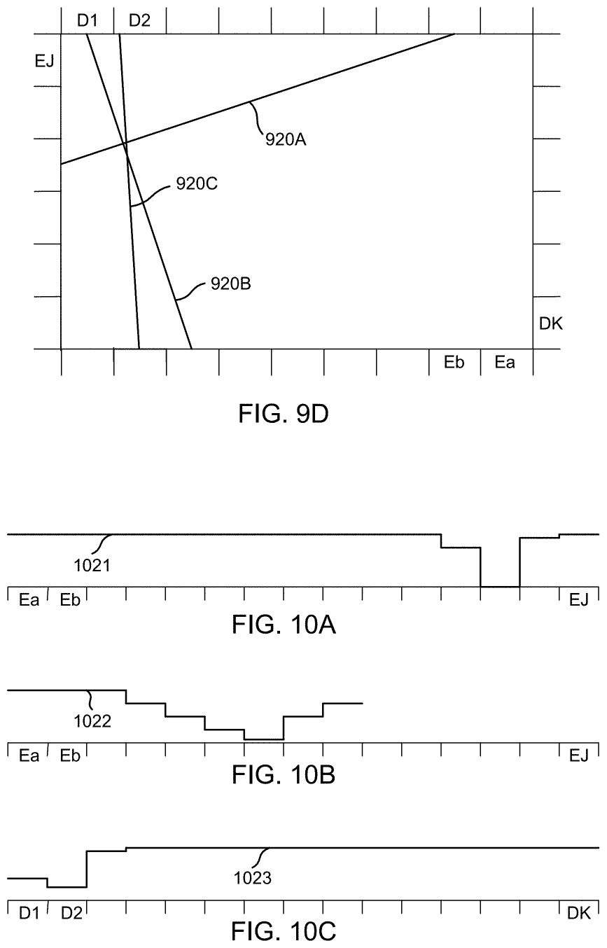

FIGS. 9-10 illustrate this concept using the emitter/detector layout shown in FIGS. 8B-8D. For convenience, the term “beam terminal” will be used to refer to emitters and detectors. Thus, the set of beams from a beam terminal (which could be either an emitter or a detector) form a line image of the touch points, where the viewpoint is the beam terminal's location.

FIGS. 9A-C shows the physical set-up of active area, emitters and detectors. In this example, there is a touch point with contact area 910. FIG. 9A shows the beam pattern for beam terminal Dk, which are all the beams from emitters Ej to detector Dk. A shaded emitter indicates that beam is interrupted, at least partially, by the touch point 910. FIG. 10A shows the corresponding line image 1021 “seen” by beam terminal Dk. The beams to terminals Ea, Eb, . . . E(J-4) are uninterrupted so the transmission coefficient is at full value. The touch point appears as an interruption to the beams with beam terminals E(J-3), E(J-2) and E(J-1), with the main blockage for terminal E(J-2). That is, the portion of the line image spanning beam terminals E(J-3) to E(J-1) is a one-dimensional image of the touch event.

FIG. 9B shows the beam pattern for beam terminal D1 and FIG. 10B shows the corresponding line image 1022 seen by beam terminal D1. Note that the line image does not span all emitters because the emitters on the left edge of the active area do not form beam paths with detector D1. FIGS. 9C and 10C show the beam patterns and corresponding line image 1023 seen by beam terminal Ej.

The example in FIGS. 9-10 use wide beam paths. However, the line image technique may also be used with narrow or fan-shaped beam paths.

FIGS. 10A-C show different images of touch point 910. The location of the touch event can be determined by processing the line images. For example, approaches based on correlation or computerized tomography algorithms can be used to determine the location of the touch event 910. However, simpler approaches are preferred because they require less compute resources.

The touch point 910 casts a “shadow” in each of the lines images 1021-1023. One approach is based on finding the edges of the shadow in the line image and using the pixel values within the shadow to estimate the center of the shadow. A line can then be drawn from a location representing the beam terminal to the center of the shadow. The touch point is assumed to lie along this line somewhere. That is, the line is a candidate line for positions of the touch point. FIG. 9D shows this. In FIG. 9D, line 920A is the candidate line corresponding to FIGS. 9A and 10A. That is, it is the line from the center of detector Dk to the center of the shadow in line image 1021. Similarly, line 920B is the candidate line corresponding to FIGS. 9B and 10B, and line 920C is the line corresponding to FIGS. 9C and 10C. The resulting candidate lines 920A-C have one end fixed at the location of the beam terminal, with the angle of the candidate line interpolated from the shadow in the line image. The center of the touch event can be estimated by combining the intersections of these candidate lines.

Each line image shown in FIG. 10 was produced using the beam pattern from a single beam terminal to all of the corresponding complimentary beam terminals (i.e., beam pattern from one detector to all corresponding emitters, or from one emitter to all corresponding detectors). As another variation, the line images could be produced by combining information from beam patterns of more than one beam terminal. FIG. 8E shows the beam pattern for emitter Ej. However, the corresponding line image will have gaps because the corresponding detectors do not provide continuous coverage. They are interleaved with emitters. However, the beam pattern for the adjacent detector Dj produces a line image that roughly fills in these gaps. Thus, the two partial line images from emitter Ej and detector Dj can be combined to produce a complete line image.

C. Location Interpolation

Applications typically will require a certain level of accuracy in locating touch points. One approach to increase accuracy is to increase the density of emitters, detectors and beam paths so that a small change in the location of the touch point will interrupt different beams.

Another approach is to interpolate between beams. In the line images of FIGS. 10A-C, the touch point interrupts several beams but the interruption has an analog response due to the beam width. Therefore, although the beam terminals may have a spacing of Δ, the location of the touch point can be determined with greater accuracy by interpolating based on the analog values. This is also shown in curve 720 of FIG. 7. The measured Tjk can be used to interpolate the x position.

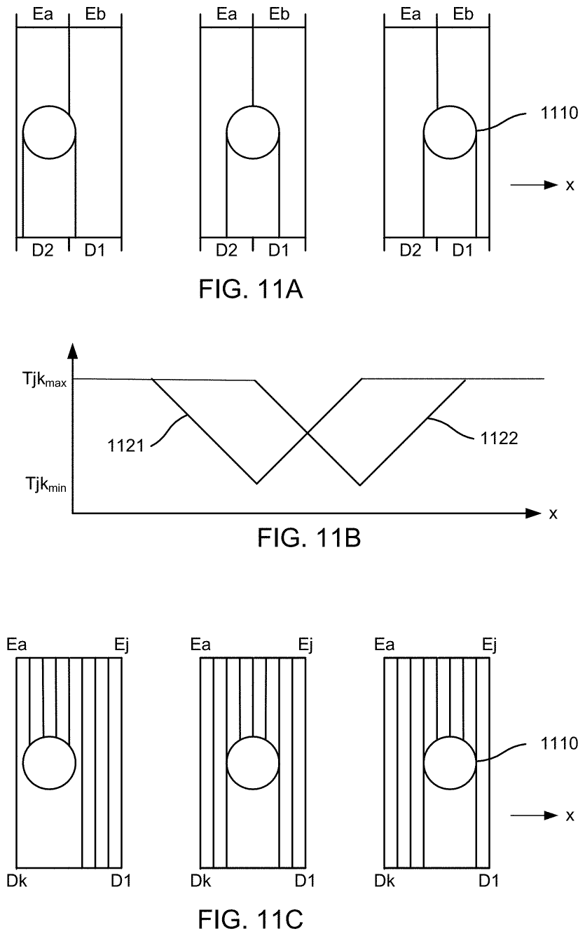

FIGS. 11A-B show one approach based on interpolation between adjacent beam paths. FIG. 11A shows two beam paths a2 and b1. Both of these beam paths are wide and they are adjacent to each other. In all three cases shown in FIG. 11A, the touch point 1110 interrupts both beams. However, in the lefthand scenario, the touch point is mostly interrupting beam a2. In the middle case, both beams are interrupted equally. In the righthand case, the touch point is mostly interrupting beam b1.

FIG. 11B graphs these two transmission coefficients as a function of x. Curve 1121 is for coefficient Ta2 and curve 1122 is for coefficient Tb1. By considering the two transmission coefficients Ta2 and Tb1, the x location of the touch point can be interpolated. For example, the interpolation can be based on the difference or ratio of the two coefficients.

The interpolation accuracy can be enhanced by accounting for any uneven distribution of light across the beams a2 and b1. For example, if the beam cross section is Gaussian, this can be taken into account when making the interpolation. In another variation, if the wide emitters and detectors are themselves composed of several emitting or detecting units, these can be decomposed into the individual elements to determine more accurately the touch location. This may be done as a secondary pass, having first determined that there is touch activity in a given location with a first pass. A wide emitter can be approximated by driving several adjacent emitters simultaneously. A wide detector can be approximated by combining the outputs of several detectors to form a single signal.

FIG. 11C shows a situation where a large number of narrow beams is used rather than interpolating a fewer number of wide beams. In this example, each beam is a pencil beam represented by a line in FIG. 11C. As the touch point 1110 moves left to right, it interrupts different beams. Much of the resolution in determining the location of the touch point 1110 is achieved by the fine spacing of the beam terminals. The edge beams may be interpolated to provide an even finer location estimate.

D. Touch Event Templates

If the locations and shapes of the beam paths are known, which is typically the case for systems with fixed emitters, detectors, and optics, it is possible to predict in advance the transmission coefficients for a given touch event. Templates can be generated a priori for expected touch events. The determination of touch events then becomes a template matching problem.

If a brute force approach is used, then one template can be generated for each possible touch event. However, this can result in a large number of templates. For example, assume that one class of touch events is modeled as oval contact areas and assume that the beams are pencil beams that are either fully blocked or fully unblocked. This class of touch events can be parameterized as a function of five dimensions: length of major axis, length of minor axis, orientation of major axis, x location within the active area and y location within the active area. A brute force exhaustive set of templates covering this class of touch events must span these five dimensions. In addition, the template itself may have a large number of elements. Thus, it is desirable to simplify the set of templates.

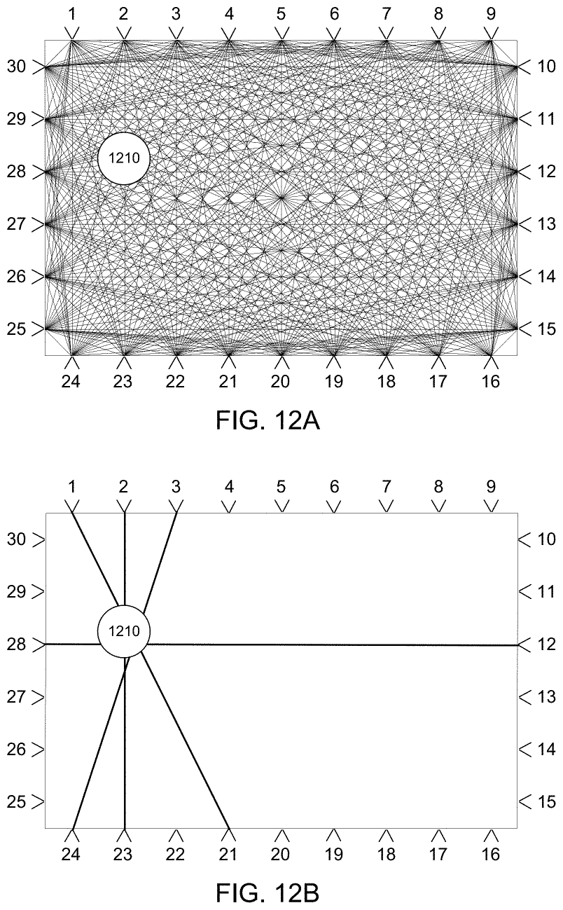

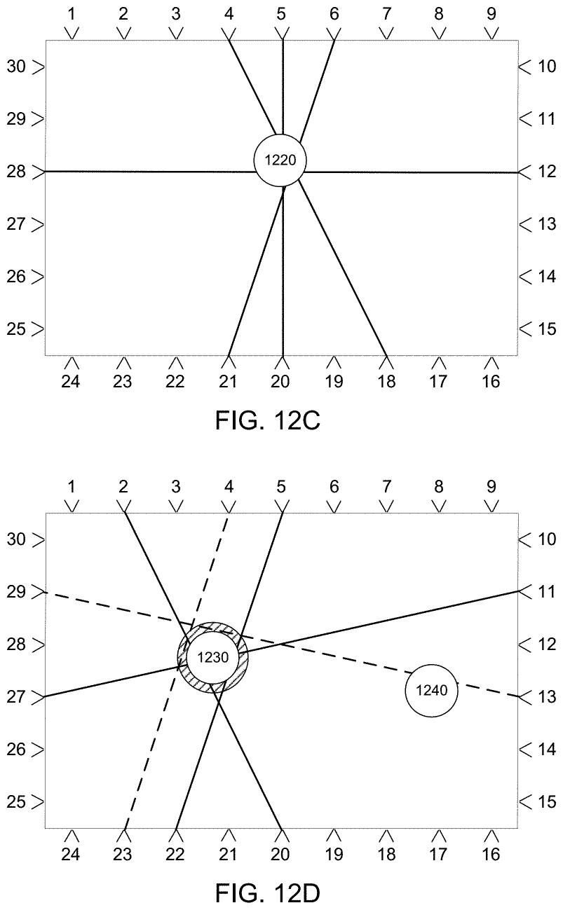

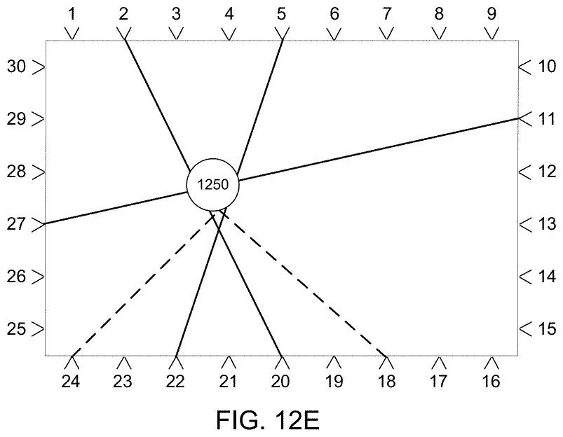

FIG. 12A shows all of the possible pencil beam paths between any two of 30 beam terminals. In this example, beam terminals are not labeled as emitter or detector. Assume that there are sufficient emitters and detectors to realize any of the possible beam paths. One possible template for contact area 1210 is the set of all beam paths that would be affected by the touch. However, this is a large number of beam paths, so template matching will be more difficult. In addition, this template is very specific to contact area 1210. If the contact area changes slightly in size, shape or position, the template for contact area 1210 will no longer match exactly. Also, if additional touches are present elsewhere in the active area, the template will not match the detected data well. Thus, although using all possible beam paths can produce a fairly discriminating template, it can also be computationally intensive to implement.

FIG. 12B shows a simpler template based on only four beams that would be interrupted by contact area 1210. This is a less specific template since other contact areas of slightly different shape, size or location will still match this template. This is good in the sense that fewer templates will be required to cover the space of possible contact areas. This template is less precise than the full template based on all interrupted beams. However, it is also faster to match due to the smaller size. These types of templates often are sparse relative to the full set of possible transmission coefficients.

Note that a series of templates could be defined for contact area 1210, increasing in the number of beams contained in the template: a 2-beam template, a 4-beam template, etc. In one embodiment, the beams that are interrupted by contact area 1210 are ordered sequentially from 1 to N. An n-beam template can then be constructed by selecting the first n beams in the order. Generally speaking, beams that are spatially or angularly diverse tend to yield better templates. That is, a template with three beam paths running at 60 degrees to each other and not intersecting at a common point tends to produce a more robust template than one based on three largely parallel beams which are in close proximity to each other. In addition, more beams tends to increase the effective signal-to-noise ratio of the template matching, particularly if the beams are from different emitters and detectors.

The template in FIG. 12B can also be used to generate a family of similar templates. In FIG. 12C, the contact area 1220 is the same as in FIG. 12B, but shifted to the right. The corresponding four-beam template can be generated by shifting beams (1,21) (2,23) and (3,24) in FIG. 12B to the right to beams (4,18) (5,20) and (6,21), as shown in FIG. 12C. These types of templates can be abstracted. The abstraction will be referred to as a template model. This particular model is defined by the beams (12,28) (i, 22−i) (i+1,24−i) (i+2,25−i) for i=1 to 6. In one approach, the model is used to generate the individual templates and the actual data is matched against each of the individual templates. In another approach, the data is matched against the template model. The matching process then includes determining whether there is a match against the template model and, if so, which value of i produces the match.

FIG. 12D shows a template that uses a “touch-free” zone around the contact area. The actual contact area is 1230. However, it is assumed that if contact is made in area 1230, then there will be no contact in the immediately surrounding shaded area. Thus, the template includes both (a) beams in the contact area 1230 that are interrupted, and (b) beams in the shaded area that are not interrupted. In FIG. 12D, the solid lines (2,20) (5,22) and (11,27) are interrupted beams in the template and the dashed lines (4,23) and (13,29) are uninterrupted beams in the template. Note that the uninterrupted beams in the template may be interrupted somewhere else by another touch point, so their use should take this into consideration. For example, dashed beam (13,29) could be interrupted by touch point 1240.

FIG. 12E shows an example template that is based both on reduced and enhanced transmission coefficients. The solid lines (2,20) (5,22) and (11,27) are interrupted beams in the template, meaning that their transmission coefficients should decrease. However, the dashed line (18,24) is a beam for which the transmission coefficient should increase due to reflection or scattering from the touch point 1250.

Other templates will be apparent and templates can be processed in a number of ways. In a straightforward approach, the disturbances for the beams in a template are simply summed or averaged. This can increase the overall SNR for such a measurement, because each beam adds additional signal while the noise from each beam is presumably independent. In another approach, the sum or other combination could be a weighted process, where not all beams in the template are given equal weight. For example, the beams which pass close to the center of the touch event being modeled could be weighted more heavily than those that are further away. Alternately, the angular diversity of beams in the template could also be expressed by weighting. Angular diverse beams are more heavily weighted than beams that are not as diverse.

In a case where there is a series of N beams, the analysis can begin with a relatively small number of beams. Additional beams can be added to the processing as needed until a certain confidence level (or SNR) is reached. The selection of which beams should be added next could proceed according to a predetermined schedule. Alternately, it could proceed depending on the processing results up to that time. For example, if beams with a certain orientation are giving low confidence results, more beams along that orientation may be added (at the expense of beams along other orientations) in order to increase the overall confidence.

The data records for templates can also include additional details about the template. This information may include, for example, location of the contact area, size and shape of the contact area and the type of touch event being modeled (e.g., fingertip, stylus, etc.).

In addition to intelligent design and selection of templates, symmetries can also be used to reduce the number of templates and/or computational load. Many applications use a rectangular active area with emitters and detectors placed symmetrically with respect to x and y axes. In that case, quadrant symmetry can be used to achieve a factor of four reduction. Templates created for one quadrant can be extended to the other three quadrants by taking advantage of the symmetry. Alternately, data for possible touch points in the other three quadrants can be transformed and then matched against templates from a single quadrant. If the active area is square, then there may be eight-fold symmetry.

Other types of redundancies, such as shift-invariance, can also reduce the number of templates and/or computational load. The template model of FIGS. 12B-C is one example.

In addition, the order of processing templates can also be used to reduce the computational load. There can be substantial similarities between the templates for touches which are nearby. They may have many beams in common, for example. This can be taken advantage of by advancing through the templates in an order that allows one to take advantage of the processing of the previous templates.

E. Multi-Pass Processing

Referring to FIG. 2, the processing phase need not be a single-pass process nor is it limited to a single technique. Multiple processing techniques may be combined or otherwise used together to determine the locations of touch events.

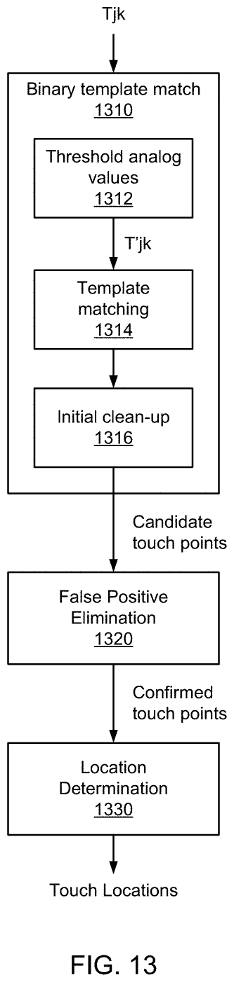

FIG. 13 is a flow diagram of a multi-pass processing phase based on several stages. This example uses the physical set-up shown in FIG. 9, where wide beams are transmitted from emitters to detectors. The transmission coefficients Tjk are analog values, ranging from 0 (fully blocked) to 1 (fully unblocked).

The first stage 1310 is a coarse pass that relies on a fast binary template matching, as described with respect to FIGS. 12B-D. In this stage, the templates are binary and the transmittances T′jk are also assumed to be binary. The binary transmittances T′jk can be generated from the analog values Tjk by rounding or thresholding 1312 the analog values. The binary values T′jk are matched 1314 against binary templates to produce a preliminary list of candidate touch points. Thresholding transmittance values may be problematic if some types of touches do not generate any beams over the threshold value. An alternative is to threshold the combination (by summation for example) of individual transmittance values.

Some simple clean-up 1316 is performed to refine this list. For example, it may be simple to eliminate redundant candidate touch points or to combine candidate touch points that are close or similar to each other. For example, the binary transmittances T′jk might match the template for a 5 mm diameter touch at location (x,y), a 7 mm diameter touch at (x,y) and a 9 mm diameter touch at (x,y). These may be consolidated into a single candidate touch point at location (x,y).

Stage 1320 is used to eliminate false positives, using a more refined approach. For each candidate touch point, neighboring beams may be used to validate or eliminate the candidate as an actual touch point. The techniques described in U.S. Pat. No. 8,350,831 may be used for this purpose. This stage may also use the analog values Tjk, in addition to accounting for the actual width of the optical beams. The output of stage 1320 is a list of confirmed touch points.

The final stage 1330 refines the location of each touch point. For example, the interpolation techniques described previously can be used to determine the locations with better accuracy. Since the approximate location is already known, stage 1330 may work with a much smaller number of beams (i.e., those in the local vicinity) but might apply more intensive computations to that data. The end result is a determination of the touch locations.

Other techniques may also be used for multi-pass processing. For example, line images or touch event models may also be used. Alternatively, the same technique may be used more than once or in an iterative fashion. For example, low resolution templates may be used first to determine a set of candidate touch locations, and then higher resolution templates or touch event models may be used to more precisely determine the precise location and shape of the touch.

F. Beam Weighting

In processing the transmission coefficients, it is common to weight or to prioritize the transmission coefficients. Weighting effectively means that some beams are more important than others. Weightings may be determined during processing as needed, or they may be predetermined and retrieved from lookup tables or lists.

One factor for weighting beams is angular diversity. Usually, angularly diverse beams are given a higher weight than beams with comparatively less angular diversity. Given one beam, a second beam with small angular diversity (i.e., roughly parallel to the first beam) may be weighted lower because it provides relatively little additional information about the location of the touch event beyond what the first beam provides. Conversely, a second beam which has a high angular diversity relative to the first beam may be given a higher weight in determining where along the first beam the touch point occurs.

Another factor for weighting beams is position difference between the emitters and/or detectors of the beams (i.e., spatial diversity). Usually, greater spatial diversity is given a higher weight since it represents “more” information compared to what is already available.

Another possible factor for weighting beams is the density of beams. If there are many beams traversing a region of the active area, then each beam is just one of many and any individual beam is less important and may be weighted less. Conversely, if there are few beams traversing a region of the active area, then each of those beams is more significant in the information that it carries and may be weighted more.

In another aspect, the nominal beam transmittance (i.e., the transmittance in the absence of a touch event) could be used to weight beams. Beams with higher nominal transmittance can be considered to be more “trustworthy” than those which have lower nominal transmittance since those are more vulnerable to noise. A signal-to-noise ratio, if available, can be used in a similar fashion to weight beams. Beams with higher signal-to-noise ratio may be considered to be more “trustworthy” and given higher weight.

The weightings, however determined, can be used in the calculation of a figure of merit (confidence) of a given template associated with a possible touch location. Beam transmittance/signal-to-noise ratio can also be used in the interpolation process, being gathered into a single measurement of confidence associated with the interpolated line derived from a given touch shadow in a line image. Those interpolated lines which are derived from a shadow composed of “trustworthy” beams can be given greater weight in the determination of the final touch point location than those which are derived from dubious beam data.

These weightings can be used in a number of different ways. In one approach, whether a candidate touch point is an actual touch event is determined based on combining the transmission coefficients for the beams (or a subset of the beams) that would be disturbed by the candidate touch point. The transmission coefficients can be combined in different ways: summing, averaging, taking median/percentile values or taking the root mean square, for example. The weightings can be included as part of this process: taking a weighted average rather than an unweighted average, for example. Combining multiple beams that overlap with a common contact area can result in a higher signal to noise ratio and/or a greater confidence decision. The combining can also be performed incrementally or iteratively, increasing the number of beams combined as necessary to achieve higher SNR, higher confidence decision and/or to otherwise reduce ambiguities in the determination of touch events.

### IV. Thin Interactive Display

Overview

Touch and display components of a large interactive display typically result in an overall design which is heavy and bulky. This may be because the touch system uses a mechanically rigid touch surface. For example, with an OTS configuration using disturbances in (e.g., infrared) energy passing over the touch surface to detect touch events, the detectors preferably have a direct and unobscured view of emitters on other sides. Thus, such systems typically have thick glass retained in a robust (heavy) mechanical frame. Some display technologies such as LCD use glass which is rigid enough to contain the liquid crystal needed for the display to operate. Additionally, the backlights needed for use with LCDs dissipate a lot of power because LCD is a subtractive technology (dark pixels block the backlight, so they often represent as big a power sink as bright pixels). This often means that the power supply is heavy and that substantial space for airflow is preserved to the rear of the device to allow heat to be carried away.

The typical form factor for such a unit is a single housing which provides the mechanical enclosure for the electronics and the support frame which is mounted to a wall or stand. As a result of the contributing factors mentioned, such a unit is typically heavy, often requiring that a wall be reinforced to support the unit. Given the weight, installation is typically undertaken by individuals with appropriate training in lifting heavy objects and securing them safely in position.

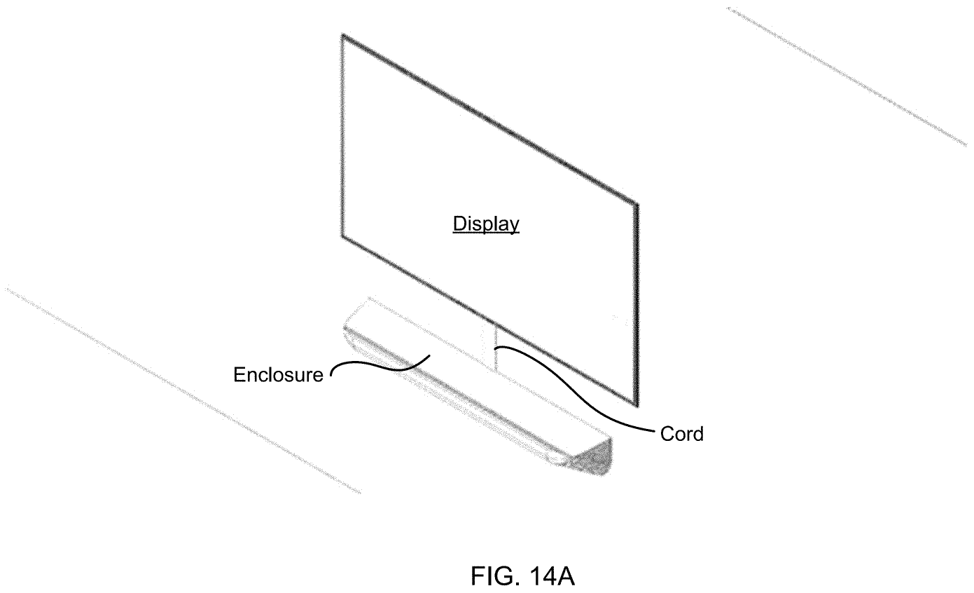

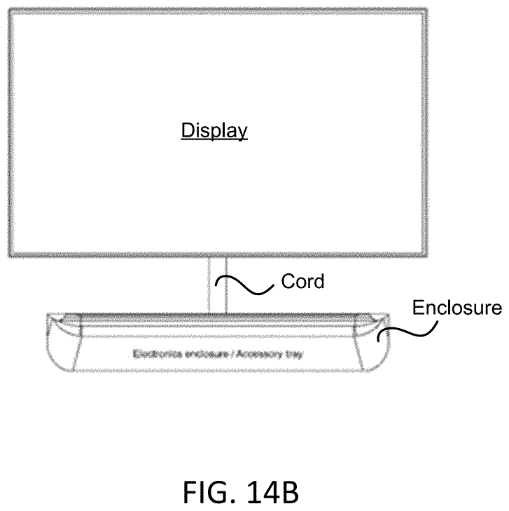

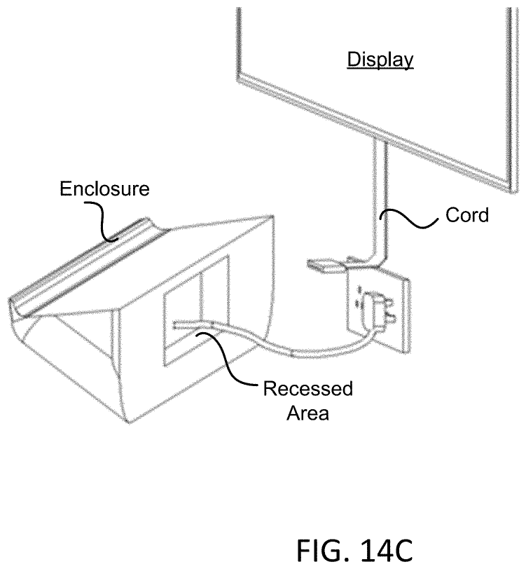

By separating the display panel from the other electronic subsystems and adopting touch sensing methods which do not require the display to be rigid, a large interactive display can be realized which is thinner and lighter and easier to install over conventional systems. For example, FIGS. 14A-14C illustrate a thin interactive display, according to some embodiments. FIGS. 14A and 14B illustrate the interactive display mounted to a wall. The interactive display includes a display, an enclosure, and a cord connected between them. Although not illustrated in FIGS. 14A-14C, the interactive display includes components that enable the interactive display to be touch sensitive. For example, a waveguide is on the front surface of the display and emitters and detectors are along the periphery of the display. The enclosure can house components configured to control the emitters and to analyze signals from the detectors to determine a location of touch events. For example, the controller 110 and the touch event processor 140 are in the enclosure. The enclosure can also house components of the display, such as a power source (components in the enclosure are further describe below). The enclosure is physically separate from the display. That is, the enclosure may be mounted on a wall or other surface independently from the display, and connected to the display via the cord. For example, in one embodiment, the enclosure is mounted to a wall at least 10 millimeters away from the display and connected only by the cord (and, of course, the wall). The cord may include multiple cables, for example connecting various components in the enclosure to the emitters and detectors.

The components residing in the enclosure may include the electronic components which drive the display itself. These components are usually too big and generate too much heat to be directly behind a display panel of the desired form factor. These display components may reside in the enclosure regardless of what type of display is used, such as LCD, OLED or μLED. The electronic components which perform the touch calculations in the touch system and power supplies of the display and the touch system may also be in the enclosure. The components associated with the waveguide on the display are typically those which are associated with the driving of the emitters and the acquisition of the optical detector signals.

For the display, the interface between the display electronics in the enclosure and the display panel itself may be one which can run over relatively long cables such as “V-by-One HS” or “V-by-One US,” which deal with the timing skews that can arise when the display data is transmitted at high speed and the display cables are long. ‘Long’ in this sense may be a length which is likely to result in a timing skew between data bits of >˜250 ps (e.g., estimated for a 4 k display refreshed at 60 Hz and driven by a parallel interface). This timing skew can be a product of differences in the cable construction between one data line and another, or the environment through which the cable passes, and various other effects. A skew of this order is likely to lead to data errors if bits are captured by a common clock edge.

For the optical touch system, the emitter current may be regulated since it is also propagating over long power cables. This can be done either by local regulation at the emitter array PCBs on the display (e.g., adjacent to the waveguide), which may use capacitive decoupling to diminish the effects of the long cables, or by using centralized regulation (in the enclosure). Centralized regulation may have to take into account the reactance of the cabling. Centralized regulation may handle all or most of the emitters, so it may have a higher power dissipation than several distributed regulators on the emitter array PCBs (local regulation). Despite the slightly more difficult electronic design, the cost of a centralized power system may be lower than for a distributed one via local regulation.

The detector data from the optical touch system may need to travel over longer cables if the touch processing is performed in the separate enclosure. Methods can be used to support long cables, for example differential transmission, or the use of single-ended transmission with signal integrity measures such as termination of the interconnections to form transmission lines. The impedance matching may be imperfect but can be good enough to maintain signal integrity while not incurring excessive costs.

Installation consists of lifting into position either the display element or the electronics enclosure first. Then, the other system component is lifted and secured. Thus, the installer does not have to support the full combined weight of the interactive display (the display and the electronics enclosure).

The total system weight can also be reduced relative to known designs by using touch sensing methods which do not require mechanical rigidity or a glass layer (although a thin glass layer can be used if desired). An example of this is the use of an FTIR touch sensor using a thin polymer waveguide, for example made from PMMA (Poly(methyl methacrylate)). The waveguide is mechanically supported by the display if it is laminated to the display. Lamination can be done using a low-tack adhesive lamination process which simplifies the typical lamination process. In the low tack adhesive lamination process air bubbles trapped between the display and waveguide can be pushed out, or the waveguide peeled back to repeat the process. Since typical lamination processes are typically expensive, this simplification is desirable. Once complete, the outer edges of the laminated waveguide can be retained using a secure adhesive or a protective retaining cover which prevents the waveguide edge from being exposed and subject to intentional or unintentional delamination.

Since a FTIR touch sensors generally do not require the waveguide to be perfectly flat, mechanical components which may otherwise be necessary to ensure rigidity may be omitted. Such a FTIR system is compatible with a wide variety of display types (for example: LCD, OLED, μLED, LED, CRT and projector), but OLED may be particularly suitable since it also offers thin and light construction which does not need a rigid support.

Having a thin overall construction for the display panel is also preferable to present a substantially vertical load to the supporting surface. Cantilever forces are reduced by decreasing the horizontal distance between the supporting surface and the center of gravity of the display panel. Thus, by having a thin display (e.g., including a touch system) the unit can be mounted on surfaces such as plasterboard or drywall which may be unsuitable mounting surfaces for conventional systems.

The system electronics (for the display and/or touch system) can be substantially or completely within the enclosure which is separate to the display panel. An enclosure which is shaped to support accessories (such as pens and erasers) for use with the interactive display panel is particularly advantageous. Connectors for external video sources (for example, HDMI, DVI, DisplayPort, VGA) can be presented to the front, side, underside or top of the enclosure such that they are readily accessed by users (much more so than those on the back or sides of conventionally configured interactive displays). In some embodiments, the touch system can interact with a video source. For example, a laptop GUI is displayed by the display and the laptop can be controlled by touching the display. Interacting with a video source may be done by including a return connection (e.g., via USB) that carries touch information (e.g., in the HID form) to the video source which is driving the display.

Additional sensors can also be present, such as proximity sensors to determine whether there is a user nearby (e.g., within 35 centimeters). Note that proximity sensors can have ranges of several meters (e.g., to determine a user is in the same room as the unit). The use of a proximity sensor can, for example, cause the unit to exit a low power mode and transition to a touch detection mode as a user approaches.

Discrete cabling (e.g., see the cord in FIGS. 14A-14C) can be used to connect the display panel to the enclosure, conveying the display signals, touch information and any other sensor and indicator data which may pass between the components (further descriptions of components in the enclosure are described below). In addition, a recessed area (e.g., see FIG. 14C) can be provided in the rear of the enclosure to accommodate and conceal connecting cables, and wall-mounted sockets and any other connections that make the device operable.

Embodiments may relate to display sizes ranging from 55″ (inches) to 110″ in the diagonal direction. The thickness (distance from the front surface to the back surface) of the display (including touch system components, such as the waveguide) may range from 1.5 to 30 mm (millimeters). A thickness of the waveguide may range from 0.02 millimeters to 1.6 millimeters. The total weight of the system (including the display and the electronics enclosure) may range from 10 to 30 kg (kilograms). As a comparison, a 75″ OTS touch sensitive display might weight between 70 kg to 100 kg. In other embodiments, the display may have different dimensions and/or weights.

Thin Waveguide

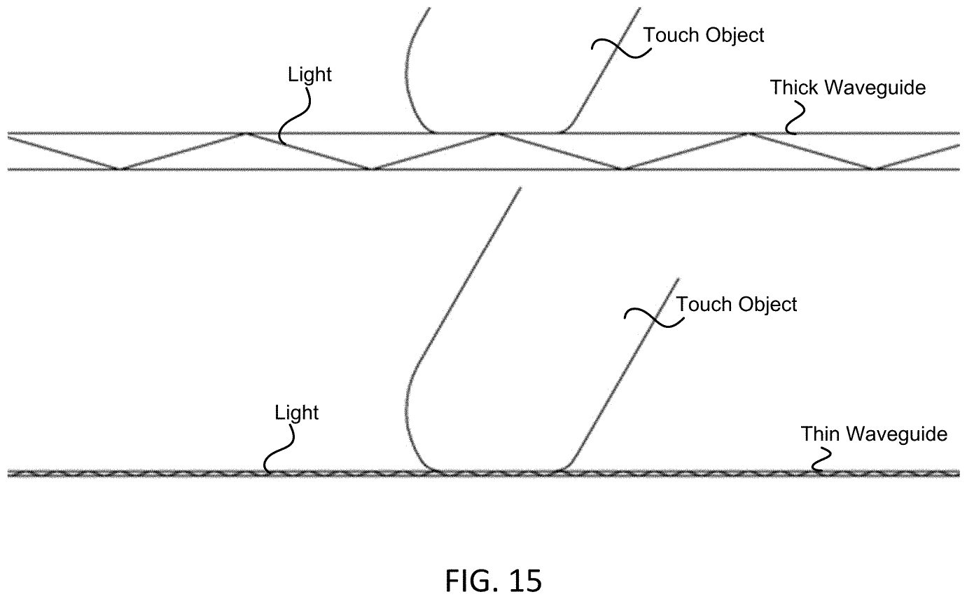

The use of a thin waveguide in an FTIR touch sensor can be problematic owing to the relatively large number of internal reflections which occur (e.g., in FIG. 15 compare the light reflections in the thick waveguide to the light reflections in the thin waveguide). For example, sensing light propagating at an elevation angle (relative to the plane of the waveguide) of 16 degrees within a 3.2 mm thick waveguide encounters the top surface every 2T/tan(θ) millimeters, where T is the waveguide thickness. For example, in a 3.2 mm waveguide, the spacing between top surface reflections is 6.4 mm/0.287=22.32 mm, whereas the spacing between top surface reflections is 2.79 mm for a waveguide which is 0.4 mm thick. The result is that there are 8 times more reflections in the 0.4 mm waveguide than for the 3.2 mm one. Since transmission through the waveguide is the compound transmission of every reflection, a large number of reflections can result in low optical transmission if there is even a small loss at each reflection. A small loss can occur over large areas of the waveguide surface when a contaminant such as sebum is deposited on the surface. Taking an example of a 1 meter waveguide span using the above reflection spacings gives 44.8 reflections in the 3.2 mm waveguide and 358 in the 0.4 mm waveguide. With an example 1% loss at each reflection caused by contamination, the overall transmission is 0.99\hat{ }44.8 for the thicker waveguide and 0.99\hat{ }358 for the thinner one. Thus, the transmission values are 63.7% and 2.7% respectively. Clearly, the thin waveguide is particularly vulnerable to contamination.

A touch event can occur even if a touch object is not in direct contact with the touch surface. If a distance between the touch object and the surface of the waveguide is of the order of the evanescent field distance of the beams (e.g., 2 μm), the touch object may disturb the beams and the touch system may determine that a touch event occurred.

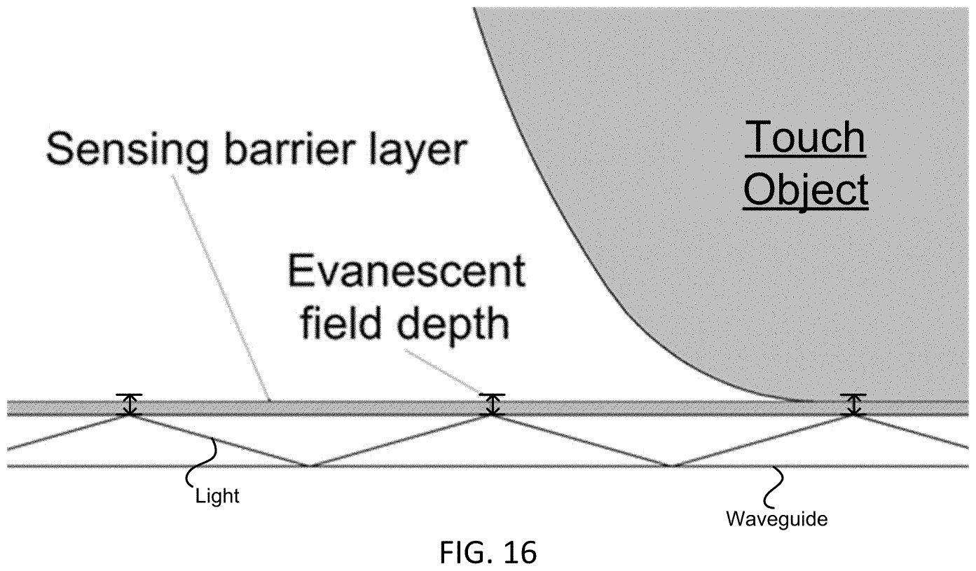

Thus, to facilitate a thinner optical waveguide construction, a sensing barrier layer can be applied to the touch surface (e.g., see barrier layer in FIG. 16). This barrier layer can be a coating which has a refractive index which is low enough to cause total internal reflection of the sensing light, but which has a thickness that is less than the depth of the evanescent field present at the boundary between the waveguide and the coating. Using such a construction, the amount of sensing light energy available at the touch surface is diminished, though the waveguide transmission is not necessarily reduced compared to a thicker waveguide. In this way, the impact of loss contamination may be reduced. For example, if the sensing barrier layer thickness is equivalent to 90% of the energy in the evanescent field, 10% of the sensing light is available for touch and contamination losses. Using the previous example of 1% loss to contamination at every reflection, this is 1% of the 10% available: 0.999\hat{ }358, which is a transmission of 69.9%. Thus, this behavior is similar to that of the thicker 3.2 mm waveguide.

When a touch is present on the surface, it has less effect on each reflection, but the larger number of reflections means that a touch of a given size encounters more light reflections. For example, an 11 mm wide touch on a 3.2 mm thick waveguide accounts for approximately half of a reflection span. If the touch results in 1% lost sensing light over its span, that is about 0.99\hat{ }0.5=0.99499=˜0.5% loss. On a 0.4 mm thick waveguide with a sensing barrier layer exposing 10% of the sensing light energy, the same contact affects approximately 4 reflections, resulting in 0.999\hat{ }4=0.996=˜0.4% loss. Thus, the performance of the thin waveguide with a sensing barrier layer is comparable to a thick waveguide without a sensing barrier layer.

As suggested above, the dimensions of the waveguide, desired beam transmission values, and the evanescent field depth may be considerations when determining the thickness of the barrier layer. The thickness of the waveguide and the length of the waveguide may be predetermined. For example, the dimensions of the waveguide are predetermined to keep the form factor and the weight of the interactive display at desired values. Furthermore, since the evanescent field depth depends on the wavelength of the light propagating in the waveguide, the evanescent field depth may be predetermined based on the emitters selected for the touch system.

In some embodiments, the thickness of the barrier layer is selected to achieve desired beam transmission values. For example, for a given waveguide thickness, the thickness of the barrier layer is selected so that the transmission of the beams is at least 20% (e.g., in the absence of a touch event and contamination on the surface). Transmission values less than 20% may have unreliable signal-to-noise ratios or may result in slower scanning (e.g., if the emitters are time division multiplexed), which may result in longer touch response times. The thickness of the barrier layer may also be based on a desired exposure level of the evanescent field. For example, depending on the thickness of the waveguide, the thickness of the barrier layer may be 30%-95% of the evanescent field depth (e.g., higher percentages for thinner waveguides).

In some cases, the barrier layer has an approximately uniform thickness across the waveguide. In other cases, the barrier layer can have a varying thickness across the waveguide. This may result in regions of the touch surface that are less affected by touch events than other regions. In some cases, portions of the barrier layer may be below the evanescent field depth and other portions of the barrier layer may be above the evanescent field depth. The portions above the evanescent field depth render portions of the waveguide touch insensitive. For example, the barrier layer is patterned with surface features where the surface features are above the evanescent field depth. Surface features (as opposed to a uniform barrier layer thickness) may reduce touch friction between a touch object and the surface of the touch system.

An alternative construction for the sensing barrier layer includes a layer of a material with a particularly high refractive index, resulting in a substantial Fresnel reflection at the interface with the waveguide. In these embodiments, a portion of the light in the waveguide may enter and propagate through the high refractive index material (e.g., over 75%). Touches may mostly (or only) disturb light propagating in the high refractive index material. Thus, since only a portion of the light passes into the high refractive index material, less light may be lost from the thin waveguide. Again, the thickness of the layer may be chosen to encompass some, but not all of the evanescent field depth so that the system can profile sufficient touch sensitivity without undue exposure to contamination. An example waveguide with a refractive index of 1.48 and a high refractive index material with a refractive index of 1.7 would reflect about 20% of light incident at the boundary at an angle of 80 degrees. Thus in this example, about 80% of the incident light may be transmitted into the high refractive material.

Anti-reflection coatings can be implemented using thin layers of low refractive index material. Anti-reflection coatings may reduce the amount of light from an external environment reflecting off the surface of the waveguide and causing glare. They can also be implemented using multiple layers of low and high refractive index material. In most anti-reflection coatings, the layer is fractions of a wavelength of light in thickness. This may reduce light reflection by forming reflected light beams that are out of phase with each other. These dimensions are similar to those of the evanescent field depth. As a result, the sensing barrier layer function may be performed by, or combined with, an anti-reflection structure on the touch surface.

In some embodiments, the sensing barrier layer is a pattern (e.g., of low refractive index material or an optically reflective material such as a metal) of surface features applied to the touch surface such that the areas with the material on the surface are not touch sensitive while the exposed areas without the material are touch sensitive. In these embodiments, the low refractive index material can optionally be thick enough to include the entire evanescent field and therefore avoid any loss into touches which contact a coated area. Where the scale (e.g., surface area) of a surface feature of the pattern is much smaller than a touch object, the effect reduces the loss from the waveguide into a given touch event. For example, a touch event of radius 5 mm has an area of approximately 78.5 square millimeters, but the sensing barrier material (e.g., metal or low refractive index material) may be applied as discs of 50 μm (micrometers) radius at 100 um center-to-center pitch. The patterned material thus covers 78.5% of the surface, leaving 21.5% exposed and sensitive to touches. Since the touch area covers about 7850 of the pattern discs, the resulting effect is that 21.5% of the evanescent energy is exposed to touches. As described in an example above, 21.5% is similar to that of a thin low refractive index layer uniformly applied to the waveguide.

### V. Applications

The touch-sensitive devices and methods described above can be used in various applications. Touch-sensitive displays are one class of application. This includes displays for tablets, laptops, desktops, gaming consoles, smart phones and other types of compute devices. It also includes displays for TVs, digital signage, public information, whiteboards, e-readers and other types of good resolution displays. However, they can also be used on smaller or lower resolution displays: simpler cell phones, user controls (photocopier controls, printer controls, control of appliances, etc.). These touch-sensitive devices can also be used in applications other than displays. The “surface” over which the touches are detected could be a passive element, such as a printed image or simply some hard surface. This application could be used as a user interface, similar to a trackball or mouse.

### VI. Additional Considerations

Upon reading this disclosure, those of skill in the art will appreciate still additional alternative structural and functional designs through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation, and details of the method and apparatus disclosed herein.

What is claimed is:

1. An interactive display comprising:
a display configured to display images;
an optical waveguide extending over a surface of the display;
emitters and detectors optically coupled to the optical waveguide, the emitters producing optical beams that propagate through the waveguide and are received by the detectors, wherein touch events on or near a surface of the optical waveguide disturb the optical beams; and
an enclosure that is physically separate from the display and the optical waveguide and configured to house electronic components configured to control the emitters and to analyze signals from the detectors to determine a location of a touch event.

2. The interactive display of claim 1, wherein a controller and a touch event processor are housed in the enclosure.

3. The interactive display of claim 2, wherein the emitters and detectors are arranged along a portion of a periphery of the optical waveguide, and further comprising:
cables connecting the controller to the emitters; and
emitter drive circuits, arranged along a portion of the periphery of the optical waveguide, and configured to regulate emitter currents in the cables.

4. The interactive display of claim 2, wherein the emitters and detectors are arranged along a portion of a periphery of the optical waveguide, and further comprising:
cables connecting the controller to the emitters; and
an emitter drive circuit housed in the enclosure and configured to regulate emitter currents in the cables.

5. The interactive display of claim 4, wherein the emitter drive circuit regulates emitter currents based on reactances of the cables.

6. The interactive display of claim 2, wherein the emitters and detectors are arranged along a portion of a periphery of the optical waveguide, and further comprising:
one or more detector acquisition circuits that convert light levels at a detector into digital values to be communicated to the controller; and
one or more cables connecting the controller to the detector acquisition circuits and configured to convey the digital values from the detector acquisition circuits to the controller, wherein a data integrity transmission technique is used to maintain signal integrity for the conveyed digital values.

7. The interactive display of claim 1, wherein a power supply of the display, emitters, and detectors is housed in the enclosure.

8. The interactive display of claim 1, wherein the waveguide includes a laminated structure with one or more layers applied to the surface of the display.

9. The interactive display of claim 1, wherein the optical waveguide is made of a polymer and conforms to the surface of the display.

10. The interactive display of claim 1, wherein the enclosure includes a proximity sensor configured to detect when a user is near the enclosure.

11. The interactive display of claim 10, wherein the electronic components housed in the enclosure are configured to transition from a low power mode to a touch detection mode responsive to the proximity sensor detecting a user is near the enclosure.

12. The interactive display of claim 1, wherein a combined thickness of the display and optical waveguide is between 1.5 millimetres and 30 millimetres.

13. The interactive display of claim 1, wherein a thickness of the optical waveguide is between 0.02 millimeters and 1.6 millimetres.

14. The interactive display of claim 1, wherein a total weight of the interactive display is between 10 kilograms and 30 kilograms.

15. The interactive display of claim 1, further comprising a barrier layer above the surface of the optical waveguide, wherein the barrier layer has an index of refraction less than an index of refraction of the optical waveguide and wherein one or more regions of the barrier layer have a thickness less than an evanescent field depth of the optical beams.

16. The interactive display of claim 15, where the thickness of the one or more regions of the barrier layer are based on the thickness of the optical waveguide.

17. The interactive display of claim 15, wherein the thickness of the one or more regions of the barrier layer are selected such that an optical transmission between each emitter and detector is at least 20% in the absence of touch events.

18. The interactive display of claim 15, wherein the one or more regions of the barrier layer have thicknesses between 30%-95% of the evanescent field depth of the optical beams.

19. The interactive display of claim 15, wherein a thickness of the barrier layer varies such that the one or more regions of the barrier layer have a thickness less than the evanescent field depth and one or more other regions have a thickness larger than the evanescent field depth.

20. The interactive display of claim 1, further comprising reflective material on one or more regions of the waveguide, wherein the one or more regions are not touch sensitive.
